(19) United States
(12) Patent Application Publication
(10) Pub. No.: US 2012/0249387 A1
(43) Pub. Date: Oct. 4, 2012

(54) DISTRIBUTED REACTANCE ANTENNA

(75) Inventor: Steve Krupa, Haifa (IL)

(73) Assignee: GALTRONICS CORPORATION LTD., Tiberias (IL)

(21) Appl. No.: 13/505,322

(22) PCT Filed: Nov. 2, 2010
(86) PCT No.: PCT/IL10/00911

§ 371 Date: Jun. 12, 2012

Related U.S. Application Data
(60) Provisional application No. 61/280,366, filed on Nov. 2, 2009.

(51) Int. Cl. H01Q 9/04

(52) U.S. Cl. 343/750; 343/749

(57) ABSTRACT

An antenna including a capacitive element and an inductive element having first and second ends, the first end of the inductive element being galvanically connected both to a feed point and to the capacitive element at a first connection point, the second end of the inductive element being galvanically connected to the capacitive element at a second connection point, the second connection point being spatially displaced from the first connection point, wherein electrical signals at the first and second connection points are mutually out of phase.

### REFERENCE TO RELATED APPLICATIONS

Reference is hereby made to U.S. Provisional Patent Application 61/280,366, entitled DISTRIBUTED REACTANCE ANTENNA, filed Nov. 2, 2009, the disclosure of which is hereby incorporated by reference and priority of which is hereby claimed pursuant to 37 CFR 1.78(a)(4) and (5)(i).

### FIELD OF THE INVENTION

The present invention relates generally to antennas and more particularly to low frequency antennas.

### BACKGROUND OF THE INVENTION

The following Patent documents are believed to represent the current state of the art:

U.S. Pat. Nos. 6,097,349 and U.S. 7,375,695.

### SUMMARY OF THE INVENTION

The present invention seeks to provide a low frequency antenna with enhanced operating bandwidth and radiating efficiency, for use in wireless communication devices.

There is thus provided in accordance with a preferred embodiment of the present invention an antenna including a capacitive element and an inductive element having first and second ends, the first end of the inductive element being galvanically connected both to a feed point and to the capacitive element at a first connection point, the second end of the inductive element being galvanically connected to the capacitive element at a second connection point, the second connection point being spatially displaced from the first connection point, wherein electrical signals at the first and second connection points are mutually out of phase.

In accordance with a preferred embodiment of the present invention a phase difference between the electrical signals at the first and second connection points is significantly greater than a phase difference associated with a straight line displacement between the first and second connection points.

In accordance with another preferred embodiment of the present invention, the inductive element includes a spatially- and phase-distributed feed element.

Preferably, the inductive element has an electrical length including a non-trivial portion of an operating wavelength of the antenna. Additionally or alternatively, the capacitive element has an electrical length including a non-trivial portion of the operating wavelength of the antenna.

In accordance with a further preferred embodiment of the present invention, the antenna is formed on a dielectric surface of a printed circuit board (PCB), the PCB preferably including a ground plane region.

Preferably, the inductive element and the capacitive element include printed elements on the surface of the PCB.

Alternatively, the inductive element and the capacitive element include three-dimensional elements.

Preferably, the inductive element includes a cylindrical coil.

Preferably, the capacitive element includes two parallel conductive plates separated by a dielectric material.

In accordance with a preferred embodiment of the present invention, the parallel conductive plates have substantially similar lengths, whereby a bandwidth of a single band of operation of the antenna is widened.

Preferably, the band of operation includes 2.3-3.7 GHz.

In accordance with another preferred embodiment of the present invention, the parallel conductive plates have substantially dissimilar lengths, whereby bandwidths of multiple bands of operation of the antenna are widened.

Preferably, the multiple bands of operation include GSM 900 and GSM 1800.

Preferably, the antenna also includes tuning components.

Preferably, the tuning components include at least one of a variable capacitor and a radio-frequency switch.

Preferably, the tuning components are mounted on the antenna using surface mount technology methods.

Preferably, the antenna also includes additional radiating elements.

### BRIEF DESCRIPTION OF THE DRAWINGS

The present invention will be understood and appreciated more fully from the following detailed description, taken in conjunction with the drawings in which:

FIGS. 1A and 1B are simplified respective perspective and top view illustrations of an antenna constructed and operative in accordance with a preferred embodiment of the present invention; and

FIGS. 2A and 2B are simplified respective perspective and top view illustrations of an antenna constructed and operative in accordance with another preferred embodiment of the present invention.

### DETAILED DESCRIPTION OF PREFERRED EMBODIMENTS

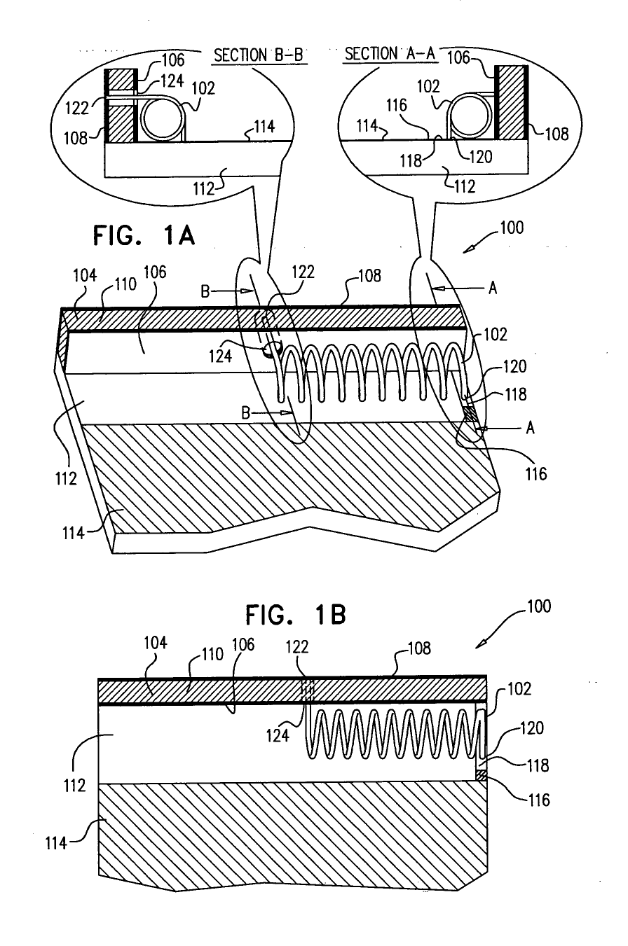

Reference is now made to FIGS. 1A and 1B, which are simplified respective perspective and top view illustrations of an antenna constructed and operative in accordance with a preferred embodiment of the present invention.

As seen in FIGS. 1A and 1B, there is provided an antenna 100, including an inductive element 102 and a capacitive element 104.

Inductive element 102 and capacitive element 104 are each preferably physically realized in a manner such that their physical dimensions and effective electrical lengths comprise non-trivial portions of an operating wavelength of antenna 100. By way of example, inductive element 102 and capacitive element 104 may have respective effective electrical lengths equal to approximately a sixth and an eighth of an operating wavelength of antenna 100.

The formation of antenna 100 from inductive and capacitive elements of such non-trivial physical and electrical lengths is in direct contrast to the typical usage of small lumped-element type inductors and capacitors within antenna structures and impedance matching networks conventionally employed by wireless devices. The use of comparatively large physically and electrically sized reactive elements confers significant operational advantages to antenna 100, by allowing inductive element 102 to act as a spatially- and phase-distributed feed element of capacitive element 104, as will be explained in greater detail below.

In the embodiment illustrated in FIGS. 1A and 1B, inductive element 102 is shown as a three-dimensional cylindrical helix and capacitive element 104 is shown as a parallel plate capacitor, preferably comprising an inner capacitor plate 106, an outer capacitor plate 108 and a dielectric core 110. It is appreciated, however, that other embodiments of inductive element 102 and capacitive element 104 are also possible, including planar, flared, tapered, spiral, or meandered inductive structures and interlaced or coaxial capacitive structures.

Inductive element 102 and capacitive element 104 are preferably installed on a common surface of a printed circuit board (PCB) 112. Inductive element 102 and capacitive element 104 are preferably formed as three-dimensional elements, mechanically positioned on and attached to the surface of PCB 112 by way of a dielectric carrier. Alternatively, inductive element 102 and capacitive element 104 may be printed on a dielectric substrate on the surface of PCB 1.12. PCB 112 preferably also includes a ground plane region 114.

Antenna 100 is preferably fed by a feed point 116, which feed point 116 is preferably contiguous with and connected to a conductive feed trunk 118. Antenna 100 is preferably compatible with a 50 Ohm RF input impedance, although it is appreciated that antenna 100 may be configured so as to be compatible with other input impedances.

A first end of inductive element 102 is preferably in galvanic contact both with feed point 116 and inner capacitor plate 106, at a connection point 120. Connection point 120 is preferably located on conductive feed trunk 118, as seen most clearly at cross-section A-A in FIG. 1A. A second end of inductive element 102 is preferably in galvanic contact with outer capacitor plate 108 at a connection point 122, as seen most clearly at cross-section B-B in FIG. 1A.

Contact between the second end of inductive element 102 and inner capacitor plate 106 is preferably avoided by means of a through-hole 124 located between capacitor plates 106 and 108, through which through-hole 124 inductive element 102 passes.

In operation of antenna 100, inner and outer capacitor plates 106 and 108 preferably act as monopole radiating elements, preferably fed by feed point 116 via connection points 120 and 122. Connection points 120 and 122 are preferably spatially distributed and, due to their respective locations at opposite ends of inductive element 102, receive or radiate radio-frequency (RF) signals that are mutually out of phase. Preferably, the phase difference between RF signals at connection points 120 and 122 is substantially greater than the phase difference associated with the straight line displacement between points 120 and 122.

It will thus be appreciated that inductive element 102, due to its size and the arrangement of its connection points 120 and 122, acts as a spatially- and phase-distributed feeding element of capacitive element 104.

It will further be appreciated that the above described arrangement of inductive element 102, capacitive element 104 and feed point 116 is somewhat analogous to a distributed parallel inductor-capacitor (LC) circuit driven by an alternating current source, wherein the reactances of the inductive and capacitive elements 102 and 104, both of which preferably have significant physical and electrical sizes in terms of an operating wavelength of antenna 100, combine to create a distributed resonance response, markedly different from the typical resonance response associated with small lumped element inductors and capacitors.

In operation, the distributed resonance response arising from the net reactances of inductive element 102 and capacitive element 104 supplements the intrinsic monopole resonance responses of inner and outer capacitor plates 106 and 108, leading to a highly significant enhancement of the overall resonance response of antenna 100, thereby improving the radiation efficiency and widening the bandwidth of antenna 100.

Furthermore, the galvanic connection between the inductive and capacitive elements 102 and 104 and the feed point 116 creates a low-impedance path for RF signals of any frequency between antenna 100 and a transceiver to which it may be connected. This distinguishes antenna 100 over conventional enhanced-bandwidth antennas in which higher RF impedances between non-galvanically connected antenna elements tend to minimize the portion of low frequency signal energy conducted to the transceiver. Antenna 100 is therefore particularly advantageous for low frequency wireless applications.

As seen in FIGS. 1A and 1B, inner capacitor plate 106 and outer capacitor plate 108 preferably have substantially similar lengths and are largely overlapping. This structure enhances the radiation efficiency and widens the operational bandwidth of antenna 100 over a single, relatively wide, band of interest. For example, the antenna embodiment of FIGS. 1A and 1B may be designed to improve the radiation efficiency of the entire range of WiMax operating bands, from 2.3-3.7 GHz.

The realizable bandwidth and radiation efficiency of antenna 100 may be modified by the adjustment of various geometric parameters associated with inductive element 102 and capacitive element 104, whereby their reactances and hence distributed resonance may be modulated. Methods for modulating the reactances of inductors and capacitors are well known in the art and include, by way of example, changing the number or spacing of turns of inductive element 102 and modifying the dimensions or separation of inner and outer capacitor plates 106 and 108.

A tunable variant of antenna 100 may be created by the incorporation of tuning components, such as RF switches and variable capacitors, into the antenna structure illustrated in FIGS. 1A and 1B. Such tuning components may be added in the form of discrete surface mount technology (SMT) components. In cases where the tuning components may potentially generate intermodulation products beyond the permissible limits of a device to which antenna 100 is connected, the tuning components may be installed in a topology which minimizes the net intermodulation products, thereby satisfying the design requirements of the host device.

In addition to inductive element 102 and capacitive element 104, other radiating and/or phasing elements may be included in antenna 100 in order to satisfy the frequency requirements of a host device. Antenna 100 may thus be adapted for operation in a wide range of devices and over a wide range of operating frequencies, including FM, DVB-H, RFID, WiFi and WiMax.

The operation of antenna 100 may be further enhanced by the inclusion of a conventional discrete passive component matching circuit between feed point 116 and the terminal end of a transmission line connected to a transceiver (not shown).

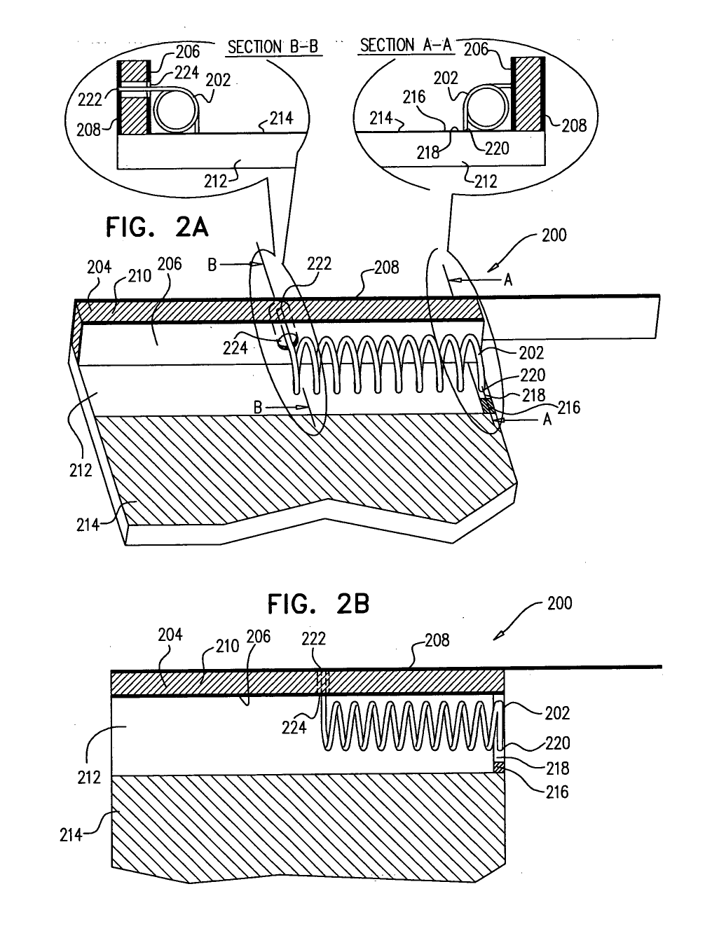

Reference is now made to FIGS. 2A and 2B which are simplified respective perspective and top view illustrations of an antenna constructed and operative in accordance with another preferred embodiment of the present invention.

As seen in FIGS. 2A and 2B there is provided an antenna 200, including an inductive element 202 and a capacitive element 204. Capacitive element 204 preferably comprises an inner capacitor plate 206 and an outer capacitor plate 208, mutually separated by a dielectric core 210. Inductive element 202 and capacitive element 204 are preferably installed on a dielectric surface of a PCB 212, which PCB 212 preferably also includes a ground plane region 214. Antenna 200 is preferably fed by a feed point 216, which feed point 216 is preferably contiguous with and connected to a conductive feed trunk 218. A first end of inductive element 202 is preferably galvanically connected both to feed point 216 and inner capacitor plate 206 at a connection point 220, which connection point 220 is preferably located on conductive feed trunk 218. A second end of inductive element 202 is preferably connected to outer capacitor plate 208 at a connection point 222. The second end of inductive element 202 preferably avoids contact with inner capacitor plate 206 by way of a through-hole 224 through which it passes.

Antenna 200 may resemble antenna 100 in every relevant respect with the exception of the relative lengths of inner capacitor plate 206 and outer capacitor plate 208. Whereas in antenna 100 inner capacitor plate 106 and outer capacitor plate 108 have substantially similar lengths and largely overlap, in antenna 200 inner capacitor plate 206, although partially overlapping with outer capacitor plate 208, is significantly shorter than outer capacitor plate 208. The disparity in length of the two capacitor plates 206 and 208 allows each plate to radiate in a different frequency band of operation, leading to a dual band rather than single wideband resonance response, as in antenna 100. Antenna 200 thus may be advantageous, for example, in providing a dual resonance antenna response for the GSM 850/900/1800/1900 operating bands.

It is appreciated that although in the embodiment of antenna 200 illustrated in FIGS. 2A and 2B inner capacitor plate 206 is shown as shorter than outer capacitor plate 208, a converse design in which outer capacitor plate 208 is shorter than inner capacitor plate 206 is also possible.

Other features and advantages of antenna 200 are substantially as described above in reference to antenna 100 of FIGS. 1A and 1B.

It will be appreciated by persons skilled in the art that the present invention is not limited by what has been particularly claimed hereinbelow. Rather the scope of the present invention includes various combinations and subcombinations of the features described hereinabove as well as modifications and variations thereof as would occur to persons skilled in the art upon reading the foregoing description with reference to the drawings and which are not in the prior art.

1. An antenna comprising:
a capacitive element; and
an inductive element having first and second ends,
said first end of said inductive element being galvanically connected both to a feed point and to said capacitive element at a first connection point,
said second end of said inductive element being galvanically connected to said capacitive element at a second connection point, said second connection point being spatially displaced from said first connection point,
wherein electrical signals at said first and second connection points are mutually out of phase.

2. An antenna according to claim 1, wherein a phase difference between said electrical signals at said first and second connection points is significantly greater than a phase difference associated with a straight line displacement between said first and second connection points.

3. An antenna according to claim 1, wherein said inductive element comprises a spatially- and phase-distributed feed element.

4. An antenna according to claim 1, wherein said inductive element has an electrical length comprising a non-trivial portion of an operating wavelength of said antenna.

5. An antenna according to claim 4, wherein said capacitive element has an electrical length comprising a non-trivial portion of said operating wavelength of said antenna.

6. An antenna according to claim 1, wherein said antenna is formed on a dielectric surface of a printed circuit board (PCB).

7. An antenna according to claim 6, wherein said PCB includes a ground plane region.

8. An antenna according to claim 6, wherein said inductive element and said capacitive element comprise printed elements on said surface of said PCB.

9. An antenna according to claim 6, wherein said inductive element and said capacitive element comprise three-dimensional elements.

10. An antenna according to claim 9, wherein said inductive element comprises a cylindrical coil.

11. An antenna according to claim 10, wherein said capacitive element comprises two parallel conductive plates separated by a dielectric material

12. An antenna according to claim 11, wherein said parallel conductive plates have substantially similar lengths, whereby a bandwidth of a single band of operation of said antenna is widened.

13. An antenna according to claim 12, wherein said band of operation comprises 2.3-3.7 GHz.

14. An antenna according to claim 11, wherein said parallel conductive plates have substantially dissimilar lengths, whereby bandwidths of multiple bands of operation of said antenna are widened.

15. An antenna according to claim 14, wherein said multiple bands of operation comprise GSM 900 and GSM 1800.

16. An antenna according to claim 1, also comprising tuning components.

17. An antenna according to claim 16, wherein said tuning components comprise at least one of a variable capacitor and a radio-frequency switch.

18. An antenna according to claim 16, wherein said tuning components are mounted on said antenna using surface mount technology methods.

19. An antenna according to claim 1, also comprising additional radiating elements.
